(19) United States
(12) Patent Application Publication
(10) Pub. No.: US 2021/0182532 A1
(43) Pub. Date: Jun. 17, 2021

(54) METHOD OF TRACKING AN ELEMENT, ASSOCIATED ELECTRONIC DEVICE AND COMPUTER PROGRAM PRODUCT

(71) Applicant: BULL SAS, Les Clayes Sous Bois (FR)

(72) Inventors: Nicolas ARNAISE, Echirolles (FR); Cécile BOUKAMEL-DONNOU, Echirolles (FR); Benoît PELLETIER, Saint Etienne De Crossey (FR)

(21) Appl. No.: 17/119,258

(22) Filed: Dec. 11, 2020

(30) Foreign Application Priority Data
Dec. 11, 2019 (FR) 19 14190

(51) Int. Cl. G06K 9/00; G06T 7/246; G07C 9/35

(52) U.S. Cl. CPC G06K 9/00154; G07C 9/35; G06T 7/248; G06K 9/00577

(57) ABSTRACT

The present invention relates to a method of tracking a reference element (E_{ref}) on images of an environment, the reference element (E_{ref}) being associated with a list of reference visual signatures, the method comprising the steps of:
reception of an image of the environment,
detection of a first element on the received image,
determination of a first visual signature for detection,
calculation of a distance between the first visual signature and a reference visual signature,
comparison of the calculated distance to a first threshold and a second threshold,
identification of the first element as being the reference element, when the distance compared is less than or equal to the first threshold, the first element being unidentified when the distance compared is strictly greater than the second threshold.

This application is based on and claims priority to French Application No. 19 14190, filed Dec. 11, 2019, the disclosure of which is incorporated by reference herein in its entirety.

The present invention relates to a method for tracking an element. The present invention also concerns an associated electronic device for tracking an element, as well as an associated computer program product.

In the field of video surveillance, tracking devices are used to track individuals over time. Such devices allow, thus, the re-identification of the individual on successive images.

In particular, tracking devices are known for which the profile of a new individual to be identified is compared to the profile of a reference individual. A score is then assigned to the comparison. The new individual to be identified is considered to be the reference individual when the score obtained for the comparison is higher than a threshold and is not identified otherwise.

However, such devices do not allow to follow an individual when his or her appearance changes, for example, if the individual takes off a garment, which is the cause of false negatives.

Therefore, there is a need for an element tracking device to reduce the rate of false negatives during tracking.

For this purpose, the object of the invention is a tracking method for tracking a reference element on successive images of an environment, the reference element being associated with a list of reference visual signatures including at least one reference visual signature, the visual signature of an element being a vector describing the appearance of the element, the method being implemented by an electronic tracking device and including at each moment the steps of:
reception of at least one image of the environment,
where applicable, detection of at least a first element on at least one received image,
determination of a first visual signature for at least one detection of each first element,
calculation, for each first element, of at least one distance between the first visual signature(s) and the reference visual signature(s),
comparison, for each first element, of a distance, as a function of the distance or distances calculated for the first element, to a first threshold and to a second threshold, the first threshold being less than or equal to the second threshold,
for each first element, identification of the first element as the reference element, when the distance compared is less than or equal to the first threshold, the first element being unidentified when the distance compared is strictly greater than the second threshold, and
where applicable, when the first element was not identified during the identification step and the first element is the same element as the reference element with a different appearance from the reference element, adding the first visual signature to the list of reference visual signatures after receiving an add user command.

Depending on other advantageous aspects of the invention, the tracking method comprises one or more of the following features, taken in isolation or in any technically possible combination:
the method further comprises the steps of:
   detection of an initial element on at least one image received earlier than the image on which the, or each first element was detected,
   determination of a visual signature for at least one detection of the initial element,
   acquisition of a tracking command of the initial element so that the initial element is the reference element, and each visual signature of the initial element is a reference visual signature from the list of reference signatures;
the first threshold is different from the second threshold;
when the distance compared is strictly greater than the first threshold and is less than or equal to the second threshold, the method comprises a step of sending a request for validation of the identification of the first element;
the method comprises a step of adding the first visual signature to the list of reference visual signatures after receiving a validation from the user in response to the validation request;
the images come from a camera network;
the reception step comprises the reception of at least two images of the environment, imaging the environment from two different viewpoints, the two images coming from two cameras of the camera network positioned at distinct locations;
each visual signature is determined by a model comprising a neural network.

The invention further relates to an electronic device for tracking a reference element over successive images of an environment, the reference element being associated with a list of reference visual signatures comprising at least one reference visual signature, the visual signature of an element being a vector describing the appearance of the element, the tracking device comprising :
an image reception channel,
a human-machine interface (HMI), and
a computer configured to implement a monitoring method as described above.

The invention also relates to a computer program product comprising a readable information carrier on which is stored a computer program including program instructions, the computer program being loadable onto a data processing unit and adapted to implement the method as described above when the computer program is implemented on the data processing unit.

Other features and advantages of the invention will appear when reading the following description of methods of carrying out the invention, given as an example only, and with reference to the drawings which are:

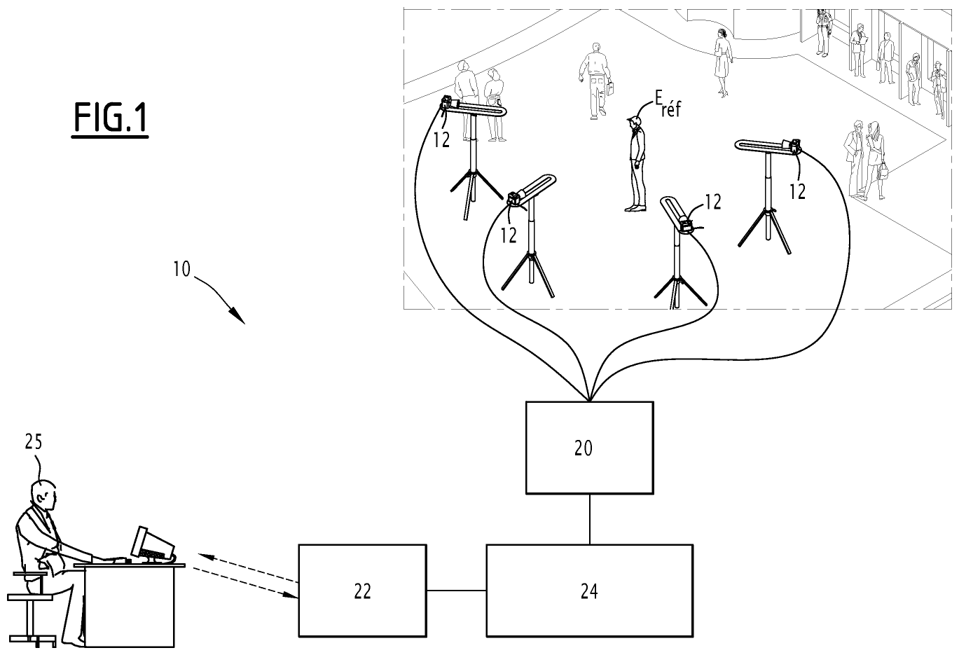

FIG. 1, a schematic representation of a tracking device receiving images from a camera network imaging an environment, and

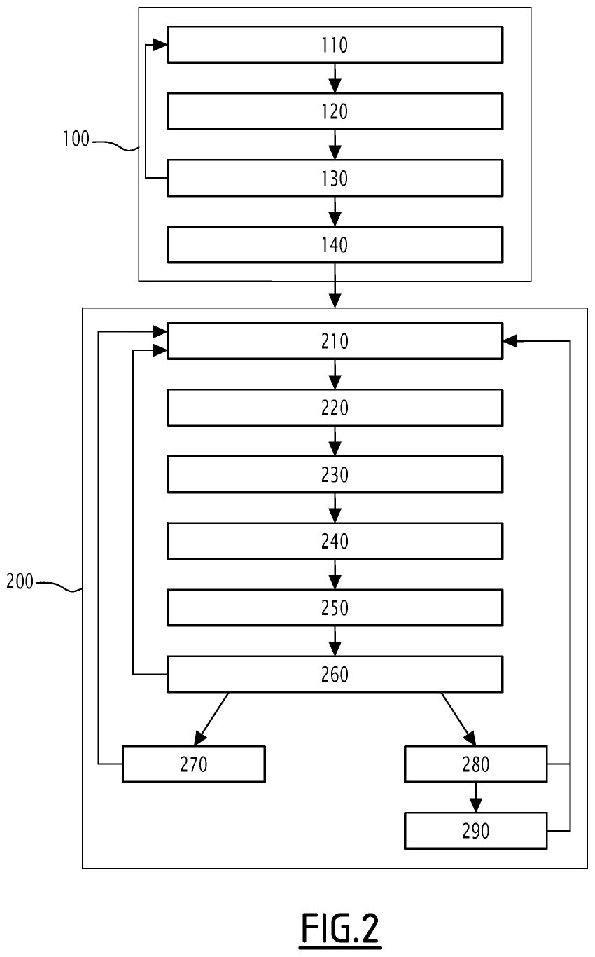

FIG. 2, a flowchart of an example of implementation of a monitoring method.

An electronic device 10 for monitoring an element E_{ref} in an environment is illustrated in FIG. 1. The environment is, for example, an urban environment.

In the example shown in FIG. 1, the environment is imaged by a camera network 12. The network cameras 12 are positioned in such a way as to image the environment from different viewpoints. In particular, the viewpoints differ between each camera depending on the weather conditions, the present environment and the position of the cameras.

Alternatively, the environment is imaged by a single camera 12.

The element E_{ref} is, for example, an individual or an animal. Alternatively, the element E_{ref} is an object, such as a vehicle.

The device 10 comprises an image reception channel 20, an HMI 22 and a computer 24.

The image reception channel 20 is intended to be connected to an image acquisition system, such as the camera network 12 shown in FIG. 1. The connection is made by wired or wireless means (for example Wi-Fi or Bluetooth connection).

The HMI 22 comprises, for example, a display and or keyboard. The HMI 22 allows requests to be sent to a user 25 and to receive commands from the user 25.

In a first example, the computer 24 comprises a processor including a data processing unit, a memory and a media reader.

In this example, the computer 24 interacts with a computer program product that contains program instructions. The computer program product is stored on a data carrier.

The data carrier is a medium that can be read by the computer 24, usually by the data processing unit of the computer 24. The readable data carrier is a medium adapted for storing electronic instructions and capable of being coupled to a bus of a computer system. For example, the readable data medium is a floppy disk, optical disk, CD-ROM, magneto-optical disk, ROM, RAM memory, EPROM memory, EEPROM memory, magnetic card, optical card, USB stick, or SSD disk. On the data carrier is stored the computer program product including program instructions.

The computer program can be loaded onto the data processing unit of the computer 24 and is adapted to implement a tracking method when the computer program is run on the data processing unit of the computer 24. The tracking method will be described in detail in the continued description.

In a second example, the computer 24 comprises one or more programmable logic components, such as FPGAs (Field Programmable Gate Array), or as dedicated integrated circuits, such as ASICs (Application Specific Integrated Circuits).

In a third example, the computer 24 comprises a central processing unit (CPU) and a graphics processing unit (GPU), with the GPU acting as a co-processor.

The operation of the monitoring system 10 allows the implementation of a monitoring method which is described with reference to the flowchart in FIG. 2.

The monitoring method comprises a first phase 100 of determining an element to be monitored, called the reference element E_{ref}, and a second phase 200 of monitoring the reference element E_{ref}.

The first phase 100 of the tracking method comprises a step 110 of receiving at least one image of an environment, for example, from the camera network 12 shown in FIG. 1.

The first phase 100 comprises, if applicable, a step 120 of detecting an initial element on at least one of the received images. The detection is, for example, carried out by a detection algorithm comprising a model for detecting categories of elements. For example, the detection algorithm uses a deep learning model of the Faster RCNN/RFCN type.

The first phase 100 comprises, then, a step 130 of determining a visual signature for at least one of the initial element detections. For example, if the initial element has been detected on several images acquired by cameras positioned at different locations, for each camera, the detection(s) of the initial element will give rise to a visual signature specific to the camera. The images of an element acquired by the same camera form an aggregate of images over time, called a “tracklet”.

The visual signature of an element is a vector describing an appearance of the element. The term “appearance” refers to the external appearance of the element (for example, the color, dimension, or shape of the element). The visual signature notably takes into account the viewpoint of the element, the technology of the camera that has acquired an image of the element or the climatic conditions, which is why a visual signature is obtained for each detection of the same element.

The visual signature is, for example, determined by a model obtained by training a neural network with an image database. For example, the visual signature is obtained according to the method described in the article entitled “Person re-identification across different datasets with multi-task learning” by Mathieu Ospici and Antoine Cecchi, published in ArXiv on Jul. 25, 2018.

If applicable, the first phase 100 comprises a step 130 of acquiring a user command to track the initial element so that the initial element is the E_{ref}. Each visual signature of the initial element is then called the reference visual signature. The reference element E_{ref} is then associated with a list of reference signatures. The reference element E_{ref} and the list of reference visual signatures are then stored at least temporarily in a memory of the computer 24.

The control is obtained via the HMI 22 of the tracking device 10.

If no tracking command is received from the user, the steps of reception 110, detection 120 and determination 130 are repeated until an element to be tracked is selected by the user.

Alternatively, the first phase 100 of the tracking method comprises only the reception of a tracking command for an element E_{ref} associated with a list of reference visual signatures, the reference element E_{ref} and the associated list having been determined prior to the tracking method.

Once the reference element E_{ref} has been determined, the second phase 200 of the tracking method is triggered.

The second phase 200 comprises a step 210 of receiving at least one image of the environment acquired subsequent to the image(s) used to determine the reference element. Generally speaking, the images received by the tracking device 10 are images acquired successively by the same acquisition system, such as the camera network 12 illustrated in FIG. 1.

Then, the second phase 200 comprises, if applicable, a step 220 of detection of at least a first element E1 on at least one received image. The detection step 220 is implemented in the same way as the detection step 120.

The second phase 200 then comprises a step 230 of determining a first visual signature for at least one detection of each first element E1. The determination step 230 is triggered in the same manner as determination step 130.

Then, the second phase 200 comprises a step 240 of calculating, for each first element E1, at least one distance between the first visual signature(s) and the reference visual signature(s).

For example, for each first element E1, a distance is obtained between a signature resulting from the average of the first visual signatures and each reference visual signature.

Alternatively, for each first element E1, a distance is obtained between each first visual signature and a signature resulting from the average of the reference visual signatures.

Again, as a variant, for each first element E1, a distance is obtained between a signature resulting from the average of the first visual signatures and a signature resulting from the average of the reference visual signatures.

Again, as a variant, for each first element E1, a distance is obtained between each first visual signature and each reference visual signature.

The, or each calculated distance is, for example, a Euclidean distance. For example, the calculated distance is obtained according to the method described in the article entitled “Person re-identification across different datasets with multi-task learning” by Mathieu Ospici and Antoine Cecchi, published in ArXiv on Jul. 25, 2018.

The second phase 200 comprises a step 250 of comparison, for each first element E1, of a distance depending on the calculated distance(s), to a first threshold S1 and to a second threshold S2. The first threshold S1 is less than or equal to the second threshold S2.

Advantageously, the first threshold S1 is different from the second threshold S2.

For example, when only one distance is obtained for the same first element, the distance compared is the calculated distance.

For example, when several distances are obtained for the same first element E1, the compared distance is the lowest distance obtained for the first element E1.

Alternatively, when several distances are obtained for the same first element E1, the compared distance is a distance resulting from the average of the distances obtained for the first element E1.

The second phase 200 then comprises, for each first element E1, a step 260 of identifying the first element E1 as being the reference element, when the compared distance is less than or equal to the first threshold S1. The first element E1 is unidentified when the compared distance is strictly greater than the second threshold S2.

Where applicable, when the first element E1 has not been identified in the identification step 260 (distance strictly greater than S2) and the first element E1 is the same element as the reference element E_{ref} with a different appearance from the reference element E_{ref}, the second phase 200 comprises a step 270 of adding the first visual signature to the list of reference visual signatures after reception of an order from the user.

The change in appearance of the first element E1 with respect to the reference element E_{ref} is, for example, induced by a change in color or shape of the first element E1. For example, when the reference element E_{ref} is an individual, the addition or removal of a garment by the individual is likely to significantly impact the appearance of the individual. Step 270 allows a user to update the list of visual signatures if they see such a change.

The command is obtained via the HMI 22 of the tracking device 10.

At the end of the addition step 270, the reception step 210, detection step 220, determination step 230, calculation step 240, comparison step 250, identification step 260 and, if applicable, the subsequent steps of the second phase 200 of the tracking method are repeated at the next instant with the updated list of visual signatures.

In the absence of the addition step 270, the reception step 210, detection step 220, determination step 230, calculation step 240, comparison step 250, identification step 260 and, if applicable, the subsequent steps of the second phase 200 of the tracking method are also repeated at the next instant with the initial list of visual signatures.

Advantageously, when the distance compared is strictly greater than the first threshold S1 and is less than or equal to the second threshold S2, the second phase 200 comprises a step 280 of sending a request for validation of the identification of the first element E1. The interval between the first threshold S1 and the second threshold S2 thus corresponds to a user consultation interval.

When, in response to the validation request, the tracking device 10 receives a validation of the identification, the second phase 200 comprises a step 290 of adding the first visual signature to the list of reference visual signatures. The command is obtained via the HMI 22 of tracking device 10.

At the end of the addition step 290, the steps of reception 210, detection 220, determination 230, calculation 240, comparison 250, identification 260 and, if applicable, the subsequent steps of the second phase 200 of the tracking method are repeated at the next instant with the updated list of visual signatures.

Thus, the present method of tracking allows an improved tracking of an element through actions to update the list of reference visual signatures following user commands.

In particular, step 270 of adding a visual signature of an unidentified element in the list of visual signatures allows tracking an element to be continued even if its visual appearance has changed. This is for example the case for an individual who adds or removes a garment. This step therefore improves the quality of tracking and reduces the rate of false negatives.

In addition, steps 280 and 290 of validation and addition allow a re-identification of the reference element E_{ref} even if the external conditions or the point of view of the element on the images have been modified or if the images are noisy. External conditions are, for example, brightness and weather. Indeed, if a new appearance occurs on a similar point of view (same camera technology, close external conditions), the re-identification method based on a signature comparison will work with a high probability (distance below the first threshold). On the other hand, if a new appearance occurs on a very different viewpoint (different camera technology, very different external conditions), the re-identification method will have a lower probability of working (distance lower than the first threshold but higher than the second threshold), hence the interest of having a user validate the identification.

Finally, the possibility of recording several reference visual signatures improves the robustness of the identifications.

Such a method can, for example, be used to identify the path of the detected element and thus constitute training data sets.

Such a method can also be used, for example, to track two coupled entities indiscriminately, such as a man and his horse, two people acting together, or a parent and their child.

Those skilled in the art will understand that the previously described embodiments or operation can be combined to form new embodiments or operation as long as they are technically compatible.

1. A method of tracking a reference element on successive images of an environment, the reference element being associated with a list of reference visual signatures comprising at least one reference visual signature, the visual signature of an element being a vector describing the appearance of the element, the method being implemented by an electronic tracking device and comprising at each instant the steps of:
reception of at least one image of the environment,
where applicable, detection of at least a first element on at least one received image,
determination of a first visual signature for at least one detection of each first element,
calculation, for each first element, of at least one distance between the first visual signature(s) and the reference visual signature(s),
comparison, for each first element, of a distance, as a function of the distance or distances calculated for the first element, with a first threshold and a second threshold, the
first threshold being less than or equal to the second threshold,
for each first element, identification of the first element as the reference element, when the distance compared is less than or equal to the first threshold, the first element being unidentified when the distance compared is strictly greater than the second threshold, and
where applicable, when the first element has not been identified during the identification step and the first element is the same element as the reference element with a different appearance from the reference element, adding the first visual signature to the list of reference visual signatures after receipt of a user's add command.

2. The method of tracking according to claim 1, wherein the method further comprises the steps of:
detection an initial element on at least one image received previously with respect to the image on which the or each first element was detected,
determination of a visual signature for at least one detection of the initial element,
acquisition of a tracking command of the initial element so that the initial element is the reference element and each visual signature of the initial element is a reference visual signature from the list of reference signatures.

3. The method of tracking according to claim 1, wherein the first threshold is different from the second threshold.

4. The method of tracking according to claim 3, wherein when the distance compared is strictly greater than the first threshold and less than or equal to the second threshold, the method comprises a step of sending a request for validation of the identification of the first element.

5. The method of tracking according to claim 4, wherein the method comprises a step of adding the first visual signature to the list of reference visual signatures after receiving a validation from the user in response to the validation request.

6. The method of tracking according to claim 1, wherein the images are from a camera network.

7. The method of tracking according to claim 6, wherein the reception step comprises reception of at least two images of the environment imaging the environment from two different viewpoints, the two images being from two cameras of the camera network positioned at separate locations.

8. The method of tracking according to claim 1, wherein each visual signature is determined by a model comprising a neural network.

9. An electronic device for tracking a reference element over successive images of an environment, the reference element being associated with a list of reference visual signatures comprising at least one reference visual signature, the visual signature of an element being a vector describing the appearance of the element, the tracking device comprising :
an image reception channel,
a human-machine interface, and
a computer configured to implement a tracking method according to claim 1.

10. A non-transitory computer-readable medium on which is stored a computer program comprising program instructions, the computer program being loadable onto a data processing unit and adapted to implement a method according to claim 1 when the computer program is implemented on the data processing unit.
